(19) United States
(12) Patent Application Publication
(10) Pub. No.: US 2024/0108007 A1
(43) Pub. Date: Apr. 4, 2024

(54) MIXED FORMULATION

(71) Applicant: Nippon Soda Co., Ltd., Chiyoda-ku, Tokyo (JP)

(72) Inventors: Yusuke FUKUSHIMA, Odowara-shi (JP); Shigeo YAMADA, Odowara-shi (JP)

(73) Assignee: Nippon Soda Co., Ltd., Chiyoda-ku, Tokyo (JP)

(21) Appl. No.: 18/272,006

(22) PCT Filed: Jan. 14, 2022
(86) PCT No.: PCT/JP2022/001075

§ 371 Date: Jul. 12, 2023

(30) Foreign Application Priority Data
Jan. 19, 2021 (JP) 2021-006207

(51) Int. Cl. A01N 43/90; A01N 47/18; A01P 1/00

(52) U.S. Cl. CPC A01N 43/90; A01N 47/18; A01P 1/00

(57) ABSTRACT

The present invention has an object to provide a composition having an action of controlling diseases of agricultural and horticultural plants caused by bacteria or the like and being capable of reducing the chemical injury and improving the leaf color, a method for controlling diseases of agricultural and horticultural plants, and a method for improving the leaf color of agricultural and horticultural plants. The present invention is the composition containing picarbutrazox and benzylaminopurine, for example, at a weight ratio of 1:100 to 100:1, and the methods, including application of the composition, or the like, for controlling diseases of agricultural and horticultural plants caused by bacteria and improving the leaf color.

### TECHNICAL FIELD

The present invention relates to a composition having an action of controlling diseases of agricultural and horticultural plants, a method for controlling diseases of agricultural and horticultural plants, and the like. In particular, the present invention relates to a composition having an action of controlling diseases of agricultural and horticultural plants caused by bacteria or the like and being capable of reducing the chemical injury and ameliorating the leaf color, a method for controlling diseases of agricultural and horticultural plants, and a method for ameliorating the leaf color of agricultural and horticultural plants. The present application claims priority from Japanese Patent Application No. 2021-006207, filed on Jan. 19, 2021, the contents of which are hereby incorporated by reference.

### BACKGROUND ART

Benzylaminopurine is a well-known plant growth regulator. Benzylaminopurine is one kind of synthetic cytokinins, and is said to have an effect of causing flowers to bloom and promoting the cell division to make fruits affluent. Further, benzylaminopurine is also said to have an effect of suppressing respiratory kinase of plants. For example, Patent Document 8 discloses a composition containing cytokinin such as benzylaminopurine. Patent Document 8 states that the composition may further contain an insecticide, a herbicide and a fungicide, or combinations thereof.

Patent Documents 1 and 2 disclose an agrochemical composition containing an agrochemical compound (a1) selected from a compound group A and an agrochemical compound (a2) selected from the compound group A, wherein the weight ratio (agrochemical compound (a2)/agrochemical compound (a1)) of the agrochemical compound (a1) to the agrochemical compound (a2) is 1/1,000 or lower. The compound group A includes a large number of compounds; among these, picarbutrazox is shown as one of fungicide compounds and benzylaminopurine is shown as one of plant growth regulator compounds. However, in Patent Documents 1 and 2, combinations of agrochemical compounds selected from the compound group A are only comprehensively listed, and a combination of picarbutrazox and benzylaminopurine is not shown, and data on the effect are not shown at all.

Meanwhile, picarbutrazox is a well-known fungicide. Although the action mechanism of picarbutrazox is unclear, it is considered that the fungicidal action is exhibited by inhibiting hyphal elongation. Compositions containing such picarbutrazox and other agrochemical ingredients are proposed.

For example, Patent Document 3 discloses a composition containing picarbutrazox and imidacloprid, triflumizole, spinosad, hydroxyisoxazole, thiophanate-methyl, tricyclazole, clothianidin, benomyl, or acetamiprid.

Patent Document 4 discloses a composition containing picarbutrazox and fosetyl, basic copper chloride, folpet, propamocarb hydrochloride, chlorothalonil, manzeb, cymoxanil, iminoctadine albesilate, cyazofamid, metalaxyl M, fludioxonil, tebuconazole, prothioconazole, thiamethoxam, or azoxystrobin.

Patent Document 5 discloses an agricultural and horticultural fungicide containing picarbutrazox and at least one selected from the group consisting of picoxystrobin, flutolanil, isoprothiolane and basic copper sulfate.

Patent Document 6 discloses: a safener for a herbicide, containing picarbutrazox; and a safener composition containing picarbutrazox and a herbicidal active ingredient.

Patent Document 7 discloses a plant growth promotor containing a tetrazoyl oxime derivative such as picarbutrazox as an active ingredient. Patent Document 7 states that the tetrazoyl oxime derivative may be used mixing with various kinds of plant growth regulators and the like for use.

### PRIOR ART DOCUMENTS

### Patent Documents

Patent Document 1: Japanese unexamined Patent Application Publication No. 2020-15768
Patent Document 2: Japanese unexamined Patent Application Publication No. 2020-15765
Patent Document 3: WO2011/115029 A
Patent Document 4: WO2009/119072 A
Patent Document 5: Japanese unexamined Patent Application Publication No. 2016-79140
Patent Document 6: WO2019/221089 A
Patent Document 7: WO2010/001563 A
Patent Document 8: Japanese unexamined Patent Application Publication (Translation of PCT Application) No. 2008-500344

### SUMMARY OF THE INVENTION

### Object to be Solved by the Invention

An object of the present invention is to provide a composition having an action of controlling diseases of agricultural and horticultural plants caused by bacteria or the like and being capable of reducing the chemical injury and ameliorating the leaf color, a method for controlling diseases of agricultural and horticultural plants, and a method for ameliorating the leaf color of agricultural and horticultural plants.

### Means to Solve the Object

As a result of studies to solve the above object, there has been achieved the completion of the present invention including the following aspects.
[1] A composition comprising picarbutrazox and benzylaminopurine.
[2] The composition according to [1], wherein the composition has an action of controlling a disease of an agricultural and horticultural plant.
[3] The composition according to [2], wherein the disease is a disease caused by a bacterium.
[4] The composition according to [2] or [3], wherein the agricultural and horticultural plant is a turf grass.
[5] The composition according to any one of [1] to [4], wherein a mass ratio between picarbutrazox and benzylaminopurine is 1:100 to 100:1.
[6] A method for controlling a disease of an agricultural and horticultural plant, comprising applying a composition according to any one of [1] to [5].
[7] A method for ameliorating a leaf color of an agricultural and horticultural plant, comprising applying a composition according to any one of [1] to [5].
[8] A method for controlling a disease of an agricultural and horticultural plant, comprising applying picarbutrazox and applying benzylaminopurine.
[9] A method for ameliorating a leaf color of an agricultural and horticultural plant, comprising applying picarbutrazox and applying benzylaminopurine.

### Effect of the Invention

The composition or the method of the present invention has the effect of preventively or therapeutically reducing diseases caused by bacteria and the like, reducing the chemical injury of objective agricultural and horticultural plants, and further allowing favorable tints of objective agricultural and horticultural plant. According to the controlling method of the present invention, diseases of agricultural and horticultural plants by bacteria and the like can be reduced preventively or therapeutically; the chemical injury can be reduced; and besides, tints of objective agricultural and horticultural plants can be favorable. Here, “can be reduced preventively” means that the composition of the present invention is applied to agricultural and horticultural plants before being infected with bacteria or the like, and if thereafter, the agricultural and horticultural plants are infected by bacteria or the like, diseases caused by the bacteria or the like can be reduced. “Can be reduced therapeutically” means that when the composition of the present invention is applied to agricultural and horticultural plants having already been infected with bacteria or the like, diseases caused by the bacteria or the like can be reduced, or the progress of the diseases can be retarded.

The composition or the method of the present invention may preferably be used, in particular, for turfs referring to surface layer portions containing leaves, stems and roots of turf grasses, and their surrounding soil.

Before the turfs are formed, when the atmospheric temperature is high, or in other occasions, the color of leaves sometimes changes to yellow or brown. According to the composition of the present invention and the controlling method of the present invention, the chemical injury may be reduced and the tint of lawn itself may be ameliorated, so the commercial value of the lawn may be enhanced.

### Mode of Carrying Out the Invention

The composition of the present invention comprises picarbutrazox and benzylaminopurine.

Picarbutrazox is a compound of formula (I) (tert-butyl=(6-{[(Z)-(1-methyl-1H-5-tetrazolyl) (phenyl)methylene]aminooxymethyl}-2-piridyl) carbamate [CAS registry number 500207-04-5]).

A technical product of picarbutrazox is usually provided as a white crystalline powder. As products containing picarbutrazox, Quintect® water dispersible granule (containing 20%, manufactured by Nippon Soda Co. Ltd.), Pythilock® flowable (containing 5%, manufactured by Nippon Soda Co. Ltd.), Naefine® dustable powder (containing 0.7%, manufactured by Nippon Soda Co. Ltd.), or the like may be exemplified.

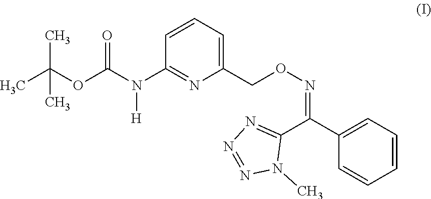 [SMILES: Cn1nnnc1/C(=N\OCc1cccc(NC(=O)OC(C)(C)C)n1)c1ccccc1]

Benzylaminopurine is a compound of formula (II) (6-benzylaminoprine, benzyladenine or BAP (CAS registry number 1214-39-7)).

A technical product of benzylaminopurine is usually provided as a white powder.

As products containing benzylaminopurine, BA® liquid formulation (manufactured by Kumiai Chemical Industry Co. Ltd.), Dorado® liquid formulation (manufactured by Rikengreen Co. Ltd.) and Prelude® liquid formulation (manufactured by Agro-Kanesho Co. Ltd.), or the like may be exemplified.

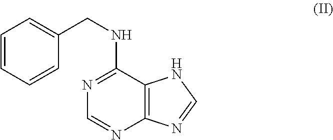 [SMILES: c1ccc(CNc2ncnc3nc[nH]c23)cc1]

The composition of the present invention is not particularly limited in terms of the mass ratio of picarbutrazox to benzylaminopurine. The mass ratio of picarbutrazox to benzylaminopurine is, for example, preferably 1/100 to 100/1, more preferably 1/50 to 50/1 and still more preferably 1/20 to 20/1.

The composition of the present invention is obtained by mixing picarbutrazox and benzylaminopurine. The mixing of picarbutrazox and benzylaminopurine may be carried out before application, or may be carried out in situ after application.

The composition of the present invention may be formulated by using a technical product of picarbutrazox and a technical product of benzylaminopurine, or alternatively may be a combination of a provided product containing picarbutrazox and a provided product containing benzylaminopurine, or may be formulated by using these products.

Formulated preparations may be in forms of usual agricultural and horticultural chemicals. As the formulation type, a dustable powder (DP), a wattable powder (WP), an emulsifiable concentrate (EC), a flowable (FL), a suspension concentrate (SC), a water soluble powder (SP), a water dispersible granule (WG), a tablet, a granule (GR), a suspo-emulsion (SE), an oil dispersion (OD), an emulsion oil in water (EW), or the like may be exemplified.

Formulation is not particularly limited in its techniques and procedure, and may be carried out by well-known techniques and procedure.

In formulation, formulation submaterials such as carriers, solvents, adjuvants and additives; and fungicides, insecticides, miticides, nematicides, soil insect pesticides, vermifuges, and non-fungicidal ingredients such as herbicides, plant growth regulators and fertilizers, may be contained in formulated preparations.

The carrier, the solvent and the adjuvant that may be contained in formulated preparations are not particularly limited as long as they do not inhibit the object of the present invention. Specific examples of the carrier and the adjuvant are regarded to be described in the present description by quoting examples thereof listed in WO2003/016303 A. As the solvent, water or an organic solvent may be used. The mass of the carrier or the adjuvant in the case of being contained in formulated preparations is not particularly limited as long as it does not inhibit the object of the present invention.

As the additives that may be contained in formulated preparations, surfactants, dispersants, antioxidants, colorants, lubricants, ultraviolet absorbers, antistatic agents, antiseptics, pH regulators, defoaming agents, specific gravity regulators, drift inhibitors, improvers in combined applications, humectants, spreaders, sticking agents, chelating agents, perfumes, or the like may be exemplified. Specific examples of the surfactant are regarded to be described in the present description by quoting examples thereof listed in WO2019/221089 A. The mass of each additive in the case of being contained in formulated preparations is not particularly limited as long as it does not inhibit the object of the present invention.

The fungicide, insecticide, miticide, nematicide, soil insect pesticide, vermifuge, herbicide, plant growth regulator, leaf color improver and fertilizer that may be contained in formulated preparations are not particularly limited as long as they do not inhibit the object of the present invention. The mass of these in the case of being contained in formulated preparations is not particularly limited, but is, with respect to picarbutrazox, preferably 1/1,000 to 1,000/1 and more preferably 1/100 to 100/1.

Specific examples of the fungicide, insecticide, miticide, nematicide and soil insect pesticide are regarded to be described in the present description by quoting examples thereof listed in WO2009/119072 A. Specific examples of the herbicide (herbicidal active ingredient) are regarded to be described in the present description by quoting examples thereof listed in WO2019/221089 A.

As the leaf color improver, GreenFerrum® (organic acid chelate iron, containing ferrous sulfate, manufactured by Nisso Green Co. Ltd.), Pentakeep® (containing aminolevulinic acid, manufactured by Seiwa Agriculture Co. Ltd.), or the like may be exemplified. These may also be used as a fertilizer.

One aspect of the method for controlling diseases of agricultural and horticultural plants and the method for ameliorating the leaf color of agricultural and horticultural plants according to the present invention comprise applying the composition of the present invention. In the methods of the present invention, depending on formulation types, the composition of the present invention or a formulated preparation containing it may be applied as it is, or may be diluted with water or the like and applied. In the methods of the present invention, the composition of the present invention or a formulated preparation containing it may be applied collectively together with other agricultural and horticultural chemicals, or may be mixed therewith and applied.

Another aspect of the method for controlling diseases of agricultural and horticultural plants and the method for ameliorating the leaf color of agricultural and horticultural plants comprise applying picarbutrazox and applying benzylaminopurine. The application of picarbutrazox and the application of benzylaminopurine may be carried out simultaneously, or may be carried out in any order. In the methods of the present invention, depending on the formulation types, a formulated preparation containing picarbutrazox or a formulated preparation containing benzylaminopurine may be applied as they are, respectively, or may be diluted with water or the like and applied, respectively. In the methods of the present invention, a formulated preparation containing picarbutrazox and/or a formulated preparation containing benzylaminopurine may be applied collectively together with other agricultural and horticultural chemicals, or may be mixed therewith and applied.

Objects of the application are plant bodies (leaves, stems, petioles, flowers, buds, fruits, seeds, sprouts, roots, tubers, tuberous roots, shoots, plant cuttings and the like), soils, hydroponic lands and the like.

In the case of the wettable powder, the emulsifiable concentrate or the flowable, these may be diluted into a predetermined concentration with water, and applied in the state of a suspension or an emulsion.

In the case of the granule or the dustable powder, these may be applied in the states as they are. The granule or the dustable powder may be preferably used for treatment of seeds, spraying to stems and leaves, application to soils and application to water surfaces.

Application to cultivation soils may be carried out before plants are planted, or may be carried out after plats are planted.

The application to soils or the application to water surfaces may be carried out so that the total amount of picarbutrazox and benzylaminopurine is an amount of 0.1 g or larger per hectare.

The treatment of seeds may be carried out so that the total amount of picarbutrazox and benzylaminopurine is an amount of 0.1 g or larger per 100 kg of seed weight. Then, the treatment of seeds may be carried out, for example, by coating or dressing seeds or tubers with the composition of the present invention, or soaking seeds or tubers in the composition of the present invention. A method of soaking root parts of plant seedlings in the composition of the present invention may also be adopted.

The treatment of stems and leaves may be carried out so that the total amount of picarbutrazox and benzylaminopurine is an amount of 0.1 g or larger per hectare.

The spraying in the method of the present invention may be carried out by using a spray gun, a chemical sprayer, an unmanned aircraft (drone, radio-controlled helicopter, radio-controlled airplane, or the like), a manned aircraft (helicopter, light airplane, or the like), an air blowing device (blower or the like), or the like. The amount to be sprayed in the method of the present invention may suitably be set according to the meteorological condition, the applying season, the applying method, the applying equipment and the like, and may be set, for example, so that the total amount of picarbutrazox and benzylaminopurine becomes, per 10 ares, preferably 1 to 500,000 g, more preferably 10 to 100,000 g and still more preferably 50 to 10,000 g.

As diseases that can be controlled by the composition and the controlling method of the present invention, there may be exemplified:
bacterial wilt (tomato, strawberry, turnip, Japanese pumpkin, cucumber, beefsteak plant, potato, garland chrysanthemum, Japanese radish, Guinea pepper, eggplant, green pepper, and the like) caused by wilt bacteria (Ralstonia solanacearum or the like);
bacterial soft rot disease (turnip, cabbage, cucumber, taro, potato, celery, Japanese radish, onion, Guinea pepper, tomato, eggplant, leek, carrot, Chinese cabbage, parsley, green pepper, broccoli, scallion, lettuce, and the like) caused by bacilli (Erwinia carotovora subsp. carotovora, Pectobacterium carotovorum or the like);
scab disease (potato) caused by actinomyces (Streptomyces spp. or the like);
brown stripe disease (rice plant, turf grass and the like) caused by bacteria causing brown stripe disease (Acidovorax avenae subsp. avenae or the like);
halo blight disease (turf grass and the like) caused by bacteria causing halo blight disease (Pseudomonas syringae pv. atrqpurprea or the like);
bacterial pustule disease (kidney bean and the like) caused by bacilli (Xanthomonas axonopodis pv. glycines or the like);
bacterial leaf blight disease (turf grass and the like) caused by bacteria (Xanthomonas campestris pv. graminis=Xanthomonas translucens or the like);
leaf sheath brown spot disease (turf grass and the like) caused by bacteria (Pseudomonas fuscovaginae or the like);
brown stripe disease (turf grass and the like) caused by bacteria (Acidovolax avenae supsp. Avenae or the like);
bacterial foot blight disease (turf grass and the like) caused by bacteria (Burkholderia plantarii or the like);
milky leaf disease (turf grass and the like) caused by bacteria; and
bacterial leaf spot disease (cucumber, soybean, lettuce, green pepper and the like) caused by bacilli (Pseudomonas syringae pv. lachrymans or the like); or the like. Here, items in parentheses are examples of objective agricultural and horticultural plants.

The agricultural and horticultural plants capable of being objective plants of the composition and the method of the present invention are not particularly limited as long as being capable of generating diseases caused by bacteria or the like. There may be exemplified:
eggplant family (Solanaceae) plants such as tomato (Solanum lycopersicum), eggplant (Solanum melongena), potato (Solanum tuberosum), Guinea pepper (Capsicum annuum), and green pepper;
rapeseed family (Brassicaceae) plants such as Japanese radish (Raphanus sativus), Chinese cabbage (Brassica rapa var. pekinensis), cabbage (Brassica oleracea var. capitata), turnip (Brassica rapa var. glabra), broccoli (Brassica oleracea var. italica), komatsuna (a kind of Chinese cabbage) (Brassica rapa var. perviridis), and cauliflower (Brassica oleracea var. botrytis);
melon family (Cucurbitaceae) plants such as cucumber (Cucumis sativus L.), western pumpkin (Cucurbita maxima), oriental pumpkin (Cucurbita moschata), watermelon (Citrulus lanatus), and zucchini (Cucurbita pepo L.);
pulse family (Fabaceae syn. Leguminosae) such as soybean (Glycine max), and kidney bean (Phaseolus vulgaris);
rose family (Rosaceae) plants such as apple (Malus pumila), pear (Pyrus pvrifolia var. culta), peach (Prunus persica), rose (Rosa sp.), and strawberry (Fragaria spp.);
labiate family (Lamiaceae) plants such as beefsteak plant (Perilla frutescens var. crispa);
aster family (Asterales) plants such as garland chrysanthemum (Glebionis coronaria), lettuce (Lactuca sativa), chrysanthemum (C. morifolium), and sunflower (H. annuus);
taro family (Araceae) plants such as taro (Coiocasia esculenta (L.) Schott);
umbelliferous family (Apiaceae) plants such as celery (Apium graveolens var. dulce), carrot (Daucus carota subsp. sativus), parsley (Petroselinum crispum), and honewort (Cryptotaenia canadensis);
cluster-amaryllis family (Arnaryllidaceae) plants such as onion (Allium cepa), Welsh onion (Allium fistulosum L), leek (Allium tuberosum), scallion (Allium chinense), and shallot (Allium cepa var. proliferum);
mallow family (Malvaceae) plants such as okura (Abelmoschus esculentus);
kijikakushi family (Asparagaceae) plants such as asparagus (Asparagus);
amaranth family (Amaranthaceae) plants such as sugar beet (Beta vulgaris ssp. vulgaris) and spinach (Spinacia oleracea);
ginger family (Zingiberaceae) plants such as ginger (Hedychium spp.), and Japanese ginger (Zingiber mioga);
tangerine family (Rutaceae) plants such as Unshiu mandarin (Citrus unshiu);
grape family (Vitaceae) plants such as grape (Vitis spp.);
plantain family (Musaceae) plants such as banana (Musa spp.);
persimmon family (Ebenaceae) plants such as Japanese persimmon (Diospyros kaki);
rice plant family (Gramineae) plants such as oat (Avena sativa), adlay (Coix lacryma-jobi var. ma-yuen), orchard grass (Dactylis glomerata), barley (Hordeum vulgare), rice (Oryza sativa), Timothy (Phleum pratense), sugarcane (Saccharum officinarum), rye wheat (Secale cereale), foxtail millet (Setaria italica), bread wheat (Triticum aestivum), corn (Zea mays), and turf grass (Zoysia spp.); or the like.

Preferably, turf grass may be exemplified.

Examples of turf grasses that are objective plants of the present invention include the following.
(1) Subfamily Eragrostoideae
Japanese turf grasses such as Japanese lawn grass, Manilagrass and Mascarenegrass;
Bermudagrasses such as Bermuda Grass, Bermudagrass, African Bermudagrass and Tifton grass; and
weeping love grass and Buffalo grass;
(2) Subfamily Panicoideae
Centipe degrass, carpet grass, Bahia grass, Dallisgrass, kikuyugrass (Pennisetum clandestinum), st. augustine grass (Stenotaphurum secundatum) and the like; and
(3) Subfamily Festucoideae
bentgrasses such as Redtop, colonial bentgrass, creeping bentgrass and velvet bentgrass;
bluegrasses such as Kentucky bluegrass (Poa pratensis), Rough Bluegrass (Poa trivialis.), Annual bluegrass, and Canada bluegrass (Poa sphondylodes Trin.);
fescues such as red fescue (Festuca rubra), chewing fescue (Festuca rubra var. commutata Gaud.), hard fescue (subsp. ovina var. duriuscula), sheep fescue, and tall fescue;
ryegrasses (Lolium perene) such as perennial ryegrass, and Italian ryegrass; and
cool temperature turf grasses such as orchard grass, timothy, smooth bromegrass, tall oat grass, crested wheatgrass, western wheatgrass, and sweet vernal grass.

Agricultural and horticultural plants capable of being objective plants of the controlling agent and the method of the present invention may also be improved varieties, variants, cultivars, as well as mutants, hybrids and genetically modified organisms (GMC) of these plants.

Hereinafter, the present invention will be described in more detail by way of Examples. However, the present invention is not any more limited to these Examples.

Substances used in the present Examples were as follows.

Bacteria 1: Acidovorax avenae (bacteria causing brown stripe disease)

(Pot evaluation test of the bacteria causing brown stripe disease to turf grass)

### EXAMPLE 1

0.5 g of commercially available Quintect® water dispersible granule (containing 20% of picarbutrazox, manufactured by Nippon Soda Co. Ltd.), 0.1 ml of a commercially available BA liquid formulation (containing 3% of benzylaminopurine, manufactured by Kumiai Chemical Industry Co. Ltd.) and 500 ml of water were mixed to thereby fabricate a chemical liquid 1 containing 200 ppm of picarbutrazox and 6 ppm of benzylaminopurine.

0.5 g of the commercially available Quintect® water dispersible granule and 500 ml of water were mixed to thereby fabricate a chemical liquid 2 containing 200 ppm of picarbutrazox.

0.1 ml of the commercially available BA liquid formulation and 500 ml of water were mixed to thereby fabricate a chemical liquid 3 containing 6 ppm of benzylaminopurine.

Turf grass (variety: bentgrass, after a lapse of 1 to 2 weeks from being sown) was transplanted in 12 pots (7 cm in length×7 cm in width×3 cm in height) to thereby prepare test pots 1 to 12, which were placed in a greenhouse.

The test pots 1 to 3 were placed in a frame (1 m in length, 1 m in width) of 1 m 2 and 500 ml of the chemical liquid 1 was uniformly sprayed to the frame by atomization.

The test pots 4 to 6 were placed in a frame (1 m in length, 1 m in width) of 1 m 2 and 500 ml of the chemical liquid 2 was uniformly sprayed to the frame by atomization.

The test pots 7 to 9 were placed in a frame (1 m in length, 1 m in width) of 1 m 2 and 500 ml of the chemical liquid 3 was uniformly sprayed to the frame by atomization.

Nothing was carried out on the test pots 10 to 12 (non-treated pots).

On the following day of the spraying of the chemical liquids, by using scissors having 100,000,000 bacteria/mi of the bacteria (bacteria causing brown stripe disease) sticked thereon, the turf grass of each pot was mown so that the length of the turf grass became about 1 cm, to thereby make the bacteria to be sticked on the turf grass.

After 7 days from the spraying of the chemical liquids, there was counted the number of lesions whose maximum length was 2 mm or longer (hereinafter, the counted number was called the diseased population). The preventive value was calculated by expression (C).

The results are shown in Table 1. It is clear that the controlling agent of the present invention had the effect of preventively reducing turf grass brown stripe disease.

Preventive value [%]=100−[(diseased population in test pot)/(diseased population in non-treated pot)]×100 (C)

After 14 days from the spraying of the chemical liquids, the leaf color of the turf grass was digitized in 1 (light green) to 7 (deep green) by using FHK leaf color scale (Fujihira Industry Co. Ltd.) corresponding to JIS color code. The results of the leaf color digitized are shown in Table 1.

FHK Color Scale . . . JIS Z8721 Standard Color Chart
1: 5-GY C8 V7
2: 5-GY C8 V6
3: 5-GY C6 V6
4: 5-GY C6 V5
5: 7. 5-GY C6 V4
6: 7. 5-GY C4 V4
7: 7. 5-GY C3 V3

TABLE 1

| | | Preventive | |
|---|---|---|---|
| | Diseased | Value | |
| | Population | [%] | Leaf Color |
| Test Pot 1 | 13 | 73 | 5 |
| Test Pot 2 | 9 | | 4 |
| Test Pot 3 | 13 | | 4 |
| Test Pot 4 | 21 | 43 | 4 |
| Test Pot 5 | 27 | | 2 |
| Test Pot 6 | 26 | | 3 |
| Test Pot 7 | 22 | 36 | 4 |
| Test Pot 8 | 33 | | 4 |
| Test Pot 9 | 27 | | 3 |
| Test Pot 10 | 40 | | 2 |
| Test Pot 11 | 48 | | 2 |
| Test Pot 12 | 41 | | 2 |

### EXAMPLE 2

Test pots 13 to 24 were prepared and tested by the same method as in Example 1, except for changing the amount of the BA liquid formulation from 0.1 ml to 0.2 ml. The results are shown in Table 2.

TABLE 2

| | | Preventive | |
|---|---|---|---|
| | Diseased | Value | |
| | Population | [%] | Leaf Color |
| Test Pot 13 | 13 | 81 | 6 |
| Test Pot 14 | 7 | | 4 |
| Test Pot 15 | 5 | | 4 |
| Test Pot 16 | 21 | 43 | 4 |
| Test Pot 17 | 27 | | 2 |
| Test Pot 18 | 26 | | 3 |
| Test Pot 19 | 20 | 50 | 5 |
| Test Pot 20 | 23 | | 4 |
| Test Pot 21 | 22 | | 4 |
| Test Pot 22 | 40 | | 2 |
| Test Pot 23 | 48 | | 2 |
| Test Pot 24 | 41 | | 2 |

### EXAMPLE 3

Test pots 25 to 36 were prepared and tested by the same method as in Example 1, except for changing the amount of the BA liquid formulation from 0.1 ml to 0.4 ml. The results are shown in Table 3.

Further, after 7 days from the spraying of the chemical liquids, there was counted the number of leaves whose tip region color changed to reddish brown, and the number was taken as a chemically injured population. The results are shown in Table 3.

TABLE 3

| | | Preventive | | Chemically |
|---|---|---|---|---|
| | Diseased | Value | | injured |
| | Population | [%] | Leaf Color | Population |
| Test Pot 25 | 7 | 81 | 6 | 3 |
| Test Pot 26 | 10 | | 4 | 3 |
| Test Pot 27 | 8 | | 4 | 4 |
| Test Pot 28 | 21 | 43 | 4 | 0 |
| Test Pot 29 | 27 | | 2 | 0 |
| Test Pot 30 | 26 | | 3 | 0 |
| Test Pot 31 | 21 | 61 | 5 | 4 |
| Test Pot 32 | 14 | | 4 | 4 |
| Test Pot 33 | 15 | | 4 | 5 |
| Test Pot 34 | 40 | | 2 | |
| Test Pot 35 | 48 | | 2 | |
| Test Pot 36 | 41 | | 2 | |

From the above results, application of the composition containing picarbutrazox and benzylaminopurine results in good disease preventive value and good leaf color. Even in the case of containing benzylaminopurine in such a concentration that chemical injury was generated (the test pots 31 to 33), application of the composition containing picarbutrazox and benzylaminopurine together (the test pots 25 and 26) can result in reduced generation of chemical injury caused by benzylaminopurine.

1. A composition comprising picarbutrazox and benzylaminopurine.

2. The composition according to claim 1, wherein the composition has an action of controlling a disease of an agricultural and horticultural plant.

3. The composition according to claim 2, wherein the disease is a disease caused by a bacterium.

4. The composition according to claim 2, wherein the agricultural and horticultural plant is a turf grass.

5. The composition according to claim 1, wherein a mass ratio between picarbutrazox and benzylaminopurine is 1:100 to 100:1.

6. A method for controlling a disease of an agricultural and horticultural plant, comprising applying a composition according to claim 1.

7. A method for ameliorating a leaf color of an agricultural and horticultural plant, comprising applying a composition according to claim 1.

8. A method for controlling a disease of an agricultural and horticultural plant, comprising applying picarbutrazox and applying benzylaminopurine.

9. A method for ameliorating a leaf color of an agricultural and horticultural plant, comprising applying picarbutrazox and applying benzylaminopurine.
